(19) United States
(12) Patent Application Publication
(10) Pub. No.: US 2011/0222327 A1
(43) Pub. Date: Sep. 15, 2011

(54) Photovoltaic Inverter Power System

(76) Inventor: Christopher Thompson, Narragansett, RI (US)

(21) Appl. No.: 12/722,129

(22) Filed: Mar. 11, 2010

(51) Int. Cl. H02M 7/515

(52) U.S. Cl. 363/135

(57) ABSTRACT

A photovoltaic system may include a DC to AC inverter including a minimum operating power setting and a microprocessor for calculating a maximum available power output for a photovoltaic array.

### TECHNICAL FIELD

The present invention relates to photovoltaic devices and methods of production.

### BACKGROUND

Photovoltaic devices can include semiconductor material deposited over a substrate, for example, with a first layer serving as a window layer and a second layer serving as an absorber layer. The semiconductor window layer can allow the penetration of solar radiation to the absorber layer, such as a cadmium telluride layer, which converts solar energy to electricity.

Photovoltaic devices can also contain one or more transparent conductive oxide layers, which are also often conductors of electrical charge.

### DESCRIPTION OF DRAWINGS

FIG. 1A is a schematic of a photovoltaic system including a DC to AC inverter.

FIG. 1B is a schematic of a photovoltaic system including a DC to AC inverter.

FIG. 2 is a flow chart of a process for operating a photovoltaic system including a DC to AC inverter.

### DETAILED DESCRIPTION

A photovoltaic device can include layers of semiconductor material. The layers of semiconductor material can include a bi-layer, which may be positioned to create an electric field. Photons can free electron-hole pairs upon making contact with the semiconductor material. The resulting electron flow provides current, which combined with the resulting voltage from the electric field, creates power. The result is the conversion of photon energy into electric power. A photovoltaic system may include an array of modules consisting of two or more submodules connected in parallel. Each submodule may include a plurality of individual cells connected in series.

An inverter can be attached to the photovoltaic array to convert DC power to AC power. In the morning there are typically low-light conditions, during which periods it can be difficult for the inverter to determine the proper time to initiate its start-up sequence. If the inverter turns on too early, it may begin the start-up sequence (which typically takes several minutes) but then fail to start. Reinitiating the start-up sequence may require a pre-defined delay, e.g., as dictated by a regulatory agency. To prevent “false-start” situations, inverters can be programmed to remain in an off state until the voltage coming from the photovoltaic array is high enough. However, this voltage may be high due to low outdoor temperature. To prevent such false starts, inverters can be programmed not to start until the voltage from the photovoltaic array is high. Because the inverters wait for substantial voltage from the photovoltaic array, there are cases where the inverter could have started, but did not because it was waiting for a high voltage. Though waiting for a high DC voltage has the benefit of minimizing false starts, it also necessitates that PV inverters wait longer than necessary before initiating the start-up sequence.

Temperature and irradiance sensors may be incorporated into a photovoltaic system, along with appropriate software, to accurately determine the ideal time for the inverter to turn on. The temperature and irradiance sensors can provide temperature and irradiance measurements to a specific algorithm or a look-up table, that is either resident on the inverter or resident on a remote computing platform. Using this approach, a highly accurate estimate of the solar array output power can be calculated. The maximum power point of the photovoltaic array may also be calculated using the temperature and irradiance measurements, thereby enabling the inverter to connect to the array at a voltage providing the most power from the array. This estimate of highest available power can then be compared to the minimum power necessary to run the inverter. Through this approach, the inverter can experience a minimum of false starts and begin at the earliest possible time with the highest possible power, thereby allowing the photovoltaic array to harvest the maximum power available.

A method of powering up a DC to AC inverter can include receiving temperature data from a temperature sensor proximate to a photovoltaic array. The method can include receiving irradiance data from an irradiance sensor proximate to a photovoltaic array. The method can include calculating a maximum available power output based on the temperature data and the irradiance data. The method can include comparing the calculated maximum available power output to a minimum operating power setting of a DC to AC inverter. The method can further include calculating a maximum power point of a photovoltaic array by any suitable means. The step of calculating a maximum available power output of the photovoltaic array can be based on the temperature data, the irradiance data, and the maximum power point.

The maximum available power output can be calculated using a look-up table. The maximum available power output can be calculated using an algorithm. The method can include powering on the DC to AC inverter if the maximum available power output is greater than or equal to the minimum operating power setting. The method can include powering off the DC to AC inverter if the maximum available power output is less than or equal to the minimum operating power setting. The temperature and/or irradiance data can be received wireless from the appropriate sensor.

A photovoltaic system may include a DC to AC inverter capable of being connected to a photovoltaic array. The DC to AC inverter can include a minimum operating power setting. Above the minimum operating power setting, the DC to AC inverter can be capable of converting DC power to AC power. The system can include a temperature sensor operable to measure and transmit information from a photovoltaic array. The system can include an irradiance sensor operable to measure and transmit irradiance information from a photovoltaic array. The system can include a microprocessor which can receive temperature information from the temperature sensor and irradiance information from the irradiance sensor. The microprocessor can be configured to calculate a maximum available power output for a photovoltaic array. The maximum available power output can be based on the temperature and/or irradiance information. The microprocessor can be configured to compare the maximum available power output to the minimum operating power setting. The DC to AC inverter may include the microprocessor. The system may include a remote computer platform, where the remote computer platform includes the microprocessor. The microprocessor may be configured to calculate a maximum power point of a photovoltaic array. The microprocessor can calculate the maximum available power output based on the temperature information, the irradiance information, and the calculated maximum power point. The microprocessor may be configured to calculate the maximum available power output, using a look-up table stored within the microprocessor, for example, in a storage device connected to the microprocessor. The microprocessor may be configured to calculate the maximum available power output, using an algorithm stored within the microprocessor, for example, in a storage device connected to the microprocessor. The microprocessor may be configured to output an ON signal to the DC to AC inverter if the maximum available power output is higher than or equal to the minimum operating power setting, where upon receiving the ON signal from the microprocessor, the DC to AC inverter begins converting DC power received from a photovoltaic array into AC power. The microprocessor may be configured to output an OFF signal to the DC to AC inverter if the maximum available power output is lower than the minimum operating power setting, where upon receiving the OFF signal from the microprocessor, the DC to AC inverter remains in an OFF state. The microprocessor may be configured to adjust a minimal operating voltage setting on the DC to AC inverter, if the maximum available power output is higher than the minimum operating power setting. The first and second data interfaces may include a form of wireless communication. The first and second data interfaces may include a form of hardwire communication. The system may include a photovoltaic array including a plurality of photovoltaic modules.

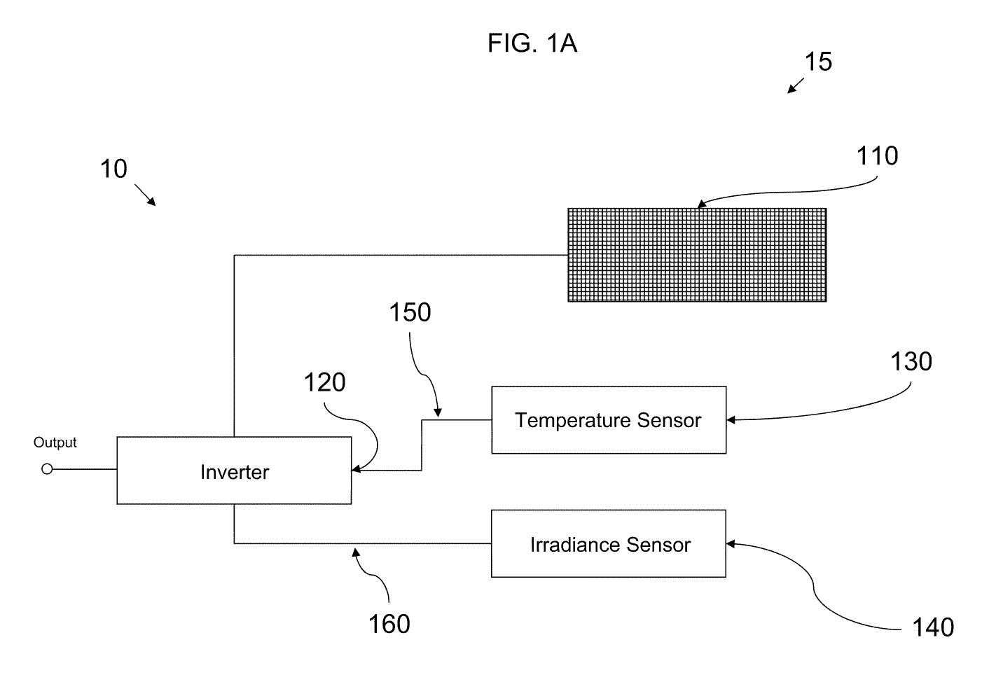

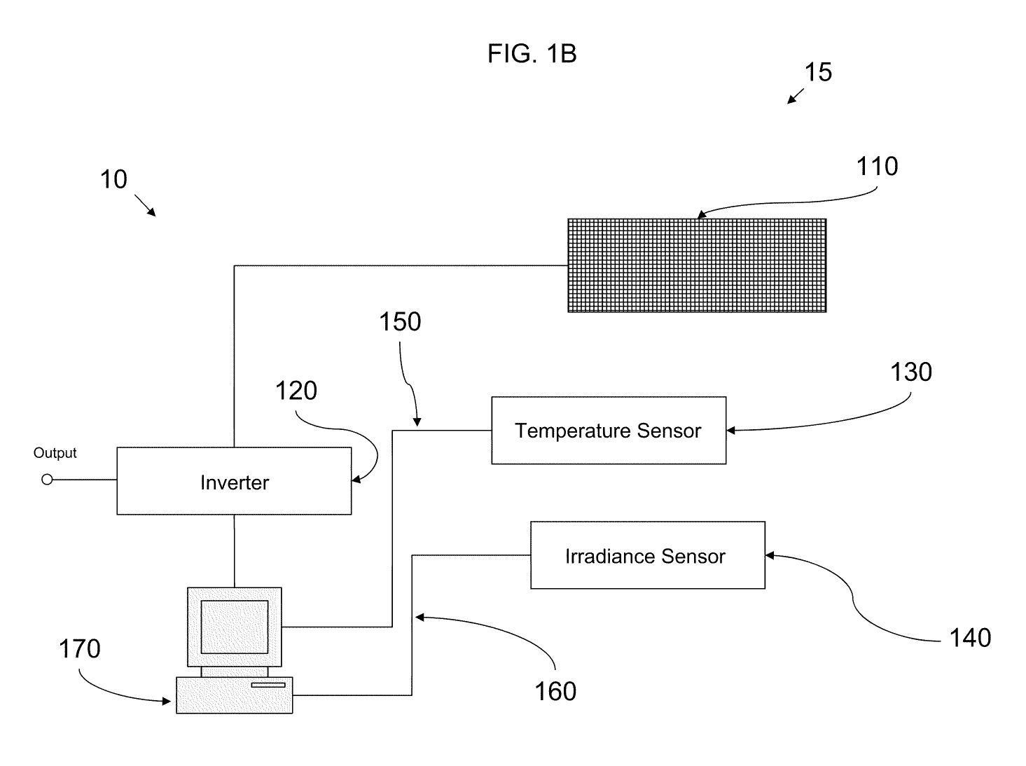

Any suitable method can be used to create the photovoltaic system discussed above. Referring to FIG. 1A, by way of example, a plurality of photovoltaic modules may be electrically connected to form photovoltaic array 110. The photovoltaic modules may include any suitable photovoltaic device material, including, for example, CIGS or cadmium telluride. Photovoltaic array 110 may be electrically connected to DC to AC conversion system 10, which along with photovoltaic array 110, may be part of photovoltaic system 15. DC to AC conversion system 10 may include inverter 120, which may be electrically connected to photovoltaic array 110 to convert DC power originating from photovoltaic array 110 into AC power for any suitable use, including, for example, a utility grid. Inverter 120 may receive temperature and irradiance information from temperature sensor 130 and irradiance sensor 140, both of which may be connected to inverter 120 via first data interface 150 and second data interface 160, respectively.

First and second data interfaces 150 and 160 may include any suitable form of communications, including, for example, any type of wireless or hardwire communications. Inverter 120 may include a controller or microprocessor to calculate a maximum available power output from photovoltaic array 110. For example, upon receiving temperature and irradiance information from temperature sensor 130 and irradiance sensor 140, inverter 120 can apply temperature and irradiance information to a lookup table stored therein, to determine the maximum available power which can be output from photovoltaic array 110, under current temperature and light conditions. Alternatively, inverter 120 can apply the received temperature and irradiance information to an algorithm programmed therein, to obtain the maximum available power output. Inverter 120 can then compare the maximum available power output to a previously stored minimum operating power, corresponding to the minimum power input necessary for inverter 120 to convert DC power to AC power.

Inverter 120 can include any suitable apparatus or combination which can convert DC current from a photovoltaic array to AC current. Inverter 140 can include any suitable mechanical device, electromechanical device, electrical or electronic device, or any suitable combination thereof. Inverter 120 can include a modified sine wave inverter. Inverter 120 can include a pure sine wave inverter. Inverter 120 can include a generator, alternator, or motor, or any suitable combination thereof. Inverter 120 can include a solid-state inverter. Inverter 120 may include a controller or microprocessor to perform the comparative and/or calculative steps, or photovoltaic system 10 may include a separate controller or microprocessor, connected to inverter 120 to perform them. Alternatively, referring to FIG. 1B, photovoltaic system 10 may include a remote computer platform 170 connected to temperature sensor 130 and irradiance sensor 140 via first data interface 150 and second data interface 160, respectively, using a form of wireless communication. Remote computing platform 170 can consist of any suitable computer hardware, including, for example, a central server to process information collected regarding photovoltaic array 110 or one or more additional photovoltaic arrays. Photovoltaic system 10 may be operated using any suitable process.

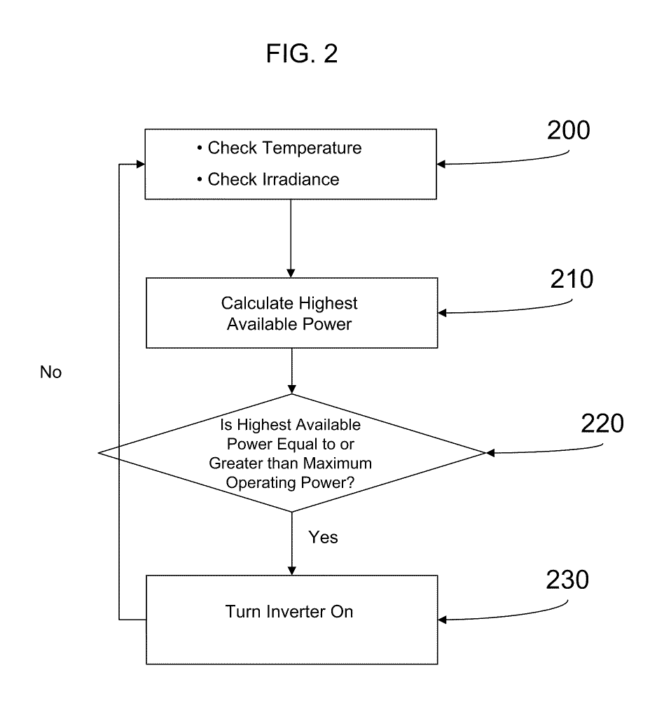

Referring to FIG. 2, by way of example, a process for operating a photovoltaic system may include a step 200, at which temperature and irradiance sensors 130 and 140 can check the temperature and irradiance levels of photovoltaic array 110. The temperature and irradiance information may be stored within inverter 120 itself, within a controller or microprocessor stored therein, or within a controller or microprocessor separate from inverter 120, for example, within remote computer platform 170. At step 210, inverter 120, or any suitable microprocessor or controller, can use the stored temperature and irradiance information to calculate a highest available power, for example, a maximum power point. At step 220, the calculated highest available power can be compared to a minimum operating power for inverter 120. If the highest available power is more than or equal to the minimum operating power, the process may proceed to step 230, at which the inverter may initiate its start-up sequence, and begin converting DC power from photovoltaic array 110 into AC power. If the highest available power is less than the minimum operating power, the process may return to step 200 to recheck the temperature and irradiance levels. This process may repeat itself until the highest available power value is more than or equal to the minimum operating power, at which point, the inverter may initiate start-up.

The embodiments described above are offered by way of illustration and example. It should be understood that the examples provided above may be altered in certain respects and still remain within the scope of the claims. It should be appreciated that, while the invention has been described with reference to the above preferred embodiments, other embodiments are within the scope of the claims.

1. A method of powering up a DC to AC inverter comprising:
receiving temperature data from a temperature sensor proximate to a photovoltaic array;
receiving irradiance data from an irradiance sensor proximate to a photovoltaic array;
calculating a maximum available power output based on the temperature data and the irradiance data; and
comparing the calculated maximum available power output to a minimum operating power setting of the DC to AC inverter.

2. The method of claim 1, further comprising calculating a maximum power point of a photovoltaic array.

3. The method of claim 2, wherein the step of calculating a maximum available power output is based on the temperature data, the irradiance data, and the maximum power point.

4. The method of claim 1, wherein the step of calculating a maximum available power output comprises using a look-up table.

5. The method of claim 1, wherein the step of calculating a maximum available power output comprises using an algorithm.

6. The method of claim 1, further comprising powering on the DC to AC inverter if the maximum available power output is greater than or equal to the minimum operating power setting.

7. The method of claim 1, further comprising powering off the DC to AC inverter if the maximum available power output is less than or equal to the minimum operating power setting.

8. The method of claim 1, wherein the temperature data are received wirelessly from the temperature sensor.

9. The method of claim 1, wherein the irradiance data are received wirelessly from the irradiance sensor.

10. A photovoltaic system comprising:
a DC to AC inverter capable of being connected to a photovoltaic array, wherein the DC to AC inverter comprises a minimum operating power setting, above which the DC to AC inverter converts DC power to AC power;
a temperature sensor operable to measure and transmit temperature information from a photovoltaic array;
an irradiance sensor operable to measure and transmit irradiance information from a photovoltaic array; and
a microprocessor which receives temperature information from the temperature sensor and irradiance information from the irradiance sensor, wherein the microprocessor is configured to calculate a maximum available power output for a photovoltaic array based on the temperature information and the irradiance information, and wherein the microprocessor is configured to compare the maximum available power output to the minimum operating power setting.

11. The system of claim 10, wherein the DC to AC inverter comprises the microprocessor.

12. The system of claim 10, further comprising a remote computer platform, wherein the remote computer platform comprises the microprocessor.

13. The system of claim 10, wherein the microprocessor is configured to calculate a maximum power point of a photovoltaic array.

14. The system of claim 13, wherein the maximum available power output for the photovoltaic array is based on the temperature information, the irradiance information, and the calculated maximum power point.

15. The system of claim 10, wherein the microprocessor is configured to calculate the maximum available power output using a look-up table stored in computer memory connected to the microprocessor.

16. The system of claim 10, wherein the microprocessor is configured to calculate the maximum available power output using an algorithm stored in computer memory connected to the microprocessor.

17. The system of claim 10, wherein the microprocessor is configured to output an ON signal to the DC to AC inverter if the maximum available power output is higher than or equal to the minimum operating power setting, wherein upon receiving the ON signal from the microprocessor, the DC to AC inverter begins converting DC power received from a photovoltaic array into AC power.

18. The system of claim 10, wherein the microprocessor is configured to output an OFF signal to the DC to AC inverter if the maximum available power output is lower than the minimum operating power setting, wherein upon receiving the OFF signal from the microprocessor, the DC to AC inverter remains in an OFF state.

19. The system of claim 10, wherein the microprocessor is configured to adjust a minimal operating voltage setting on the DC to AC inverter if the maximum available power output is higher than the minimum operating power setting.

20. The system of claim 10, wherein the temperature sensor transmits temperature data to the microprocessor wirelessly.

21. The system of claim 10, wherein the irradiance sensor transmits irradiance data to the microprocessor wirelessly.

22. The system of claim 10, further comprising a photovoltaic array including a plurality of photovoltaic modules.
